(19) United States
(12) Patent Application Publication
(10) Pub. No.: US 2017/0262570 A1
(43) Pub. Date: Sep. 14, 2017

(54) Layout Design Repair Using Pattern Classification

(71) Applicant: Mentor Graphics Corporation, Wilsonville, OR (US)

(72) Inventor: Kyohei Sakajiri, Portland, OR (US)

(21) Appl. No.: 15/068,519

(22) Filed: Mar. 11, 2016

(51) Int. Cl. G06F 17/50

(52) U.S. Cl. CPC G06F 17/5081; G06F 2217/12

(57) ABSTRACT

Geometric elements within regions needing lithographic repair are examined to identify characteristics of the patterns formed by those geometric elements. Repair regions with common pattern characteristics then are categorized into classes. When a repair solution is determined for a selected repair region, that repair solution is applied to the other repair regions in the same class as the selected repair region. In some implementations, the repair solution is applied to every instance of a repair region within the class. With still other implementations, the hierarchy of the layout design is examined to determine a hierarchical cell that includes all of the design elements of the selected repair region. The repair solution can then be applied to the design elements within that cell, propagating the repair throughout the design.

### FIELD OF THE INVENTION

The present invention is directed the repair of layout design data. More particularly, various implementations of the disclosed technology may be useful for efficiently identifying and repairing regions within a layout design that may not be correctly manufactured during a manufacturing process.

### BACKGROUND

Electronic circuits, such as integrated microcircuits, are used in a variety of products, from automobiles to microwaves to personal computers. Designing and fabricating microcircuit devices typically involves many steps, known as a “design flow.” The particular steps of a design flow often are dependent upon the type of microcircuit being designed, its complexity, the design team, and the microcircuit fabricator or foundry that will manufacture the microcircuit. Typically, software and hardware “tools” will verify a design at various stages of the design flow by running software simulators and/or hardware emulators, and errors in the design are corrected.

Several steps are common to most design flows. Initially, the specification for the new microcircuit is transformed into a logical design, sometimes referred to as a register transfer level (RTL) description of the circuit. With this logical design, the circuit is described in terms of both the exchange of signals between hardware registers and the logical operations that are performed on those signals. The logical design typically employs a Hardware Design Language (HDL), such as the Very high speed integrated circuit Hardware Design Language (VHDL). The logic of the circuit is then analyzed, to confirm that the logic incorporated into the design will accurately perform the functions desired for the circuit. This analysis is sometimes referred to as “functional verification.”

After the accuracy of the logical design is confirmed, it is converted into a device design by synthesis software. The device design, which is typically in the form of a schematic or netlist, describes the specific electronic devices (such as transistors, resistors, and capacitors) that will be used in the circuit, along with their interconnections. This logical generally corresponds to the level of representation displayed in conventional circuit diagrams. Preliminary timing estimates for portions of the circuit may be made at this stage, using an assumed characteristic speed for each device. In addition, the relationships between the electronic devices are analyzed, to confirm that the circuit described by the device design will correctly perform the functions desired for the circuit. This analysis is sometimes referred to as “formal verification.”

Once the relationships between circuit devices have been established, the design is again transformed, this time into a physical design that describes specific geometric elements. This type of design often is referred to as a “layout” design. The geometric elements define the shapes that will be created in various materials to actually manufacture the circuit device components (e.g., contacts, channels, gates, etc.) making up the circuit. While the geometric elements are typically polygons, other shapes, such as circular and elliptical shapes, may be employed. These geometric elements may be custom designed, selected from a library of previously-created designs, or some combination of both. Geometric elements also are added to form the connection lines that will interconnect these circuit devices. Layout tools (often referred to as “place and route” tools), such as IC Station available from Mentor Graphics® Corporation of Wilsonville, Oreg. or Virtuoso available from Cadence® Design Systems of San Jose, Calif., are commonly used for both of these tasks.

With a layout design, each physical layer of the microcircuit will have a corresponding layer representation in the layout design data, and the geometric elements described in a layer representation will define the relative locations of the circuit device components that will make up a circuit device. Thus, the geometric elements in the representation of an implant layer will define the regions where doping will occur, while the geometric elements in the representation of a metal layer may define the locations in a metal layer where conductive wires will be formed to connect the circuit devices. Typically, a designer will perform a number of analyses on the layout design. For example, the layout design may be analyzed to confirm that it accurately represents the circuit devices and their relationships described in the device design. The layout design also may be analyzed to confirm that it complies with various design requirements, such as minimum spacings between geometric elements. Still further, it may be modified to include the use of redundant or other compensatory geometric elements intended to counteract limitations in the manufacturing process, etc. This analysis is sometimes referred to as “physical verification.”

After the layout design has been finalized, then it is converted into a format that can be employed by a mask or reticle writing tool to create a mask or reticle for use in a photolithographic manufacturing process. Masks and reticles are typically made using tools that expose a blank reticle to an electron or laser beam. Most mask writing tools are able to only “write” certain kinds of polygons, however, such as right triangles, rectangles or other trapezoids. Moreover, the sizes of the polygons are limited physically by the maximum beam aperture size available to the tool. Accordingly, larger geometric elements in the layout design, or geometric elements that are not basic right triangles, rectangles or trapezoids (which typically is a majority of the geometric elements in a layout design) must be “fractured” into the smaller, more basic polygons that can be written by the mask or reticle writing tool.

Once the layout design has been fractured, then the layout design data can be converted to a format compatible with the mask or reticle writing tool. Examples of such formats are MEBES, for raster scanning machines manufactured by ETEC, an Applied Materials Company, the “.MIC” format from Micronics AB in Sweden, and various vector scan formats for Nuflare, JEOL, and Hitachi machines, such as VSB12 or VSB12. The written masks or reticles can then be used in a photolithographic process to expose selected areas of a wafer in order to produce the desired integrated circuit devices on the wafer.

Returning to the creation of layout design data, computational lithography has evolved into a key technology for creating highly optimized lithographic masks from physical layout design data of large scale semiconductor designs. Computational lithography encompasses a variety of manufacturing improvement techniques, such as include Resolution Enhancement Technology (RET), Optical Proximity Correction (OPC), Source Mask Optimization (SMO), etc. Computational lithography conventionally is applied to the entirety of a design, but even after one or more computational lithography techniques has been applied to the entirety of a design, it may still contain a number of regions or “hotspots” that will have printability problems. For example, a broadly-applied computational lithography process could cause insufficient results for a variety of reasons, such as the OPC recipe not being tuned well, mask rule check (MRC) errors restricting the corrective movements an OPC process, convergence not being achieved due to process window constraints that are too aggressive, and software problems such as tiling border issues.

To address these hotspots, local printability enhancement (LPE) techniques have been used to apply computational lithography to improve the printability of specific regions within a design. Thus, these techniques can be applied to improve the printability of problematic regions (sometimes referred to as “repairing hotspots”) without having to process a larger portion of the design. While such a localized design refinement on a relatively small number of hotspots is quite useful, it is possible to have a large number of hotspots in a design, which conventionally requires that a large amount of data be processed.

### SUMMARY

Some disclosed embodiments may be useful for repairing layout design data, and particularly for repairing multiple hotspots formed by repetitive patterns of geometric elements, such as with designs for memory devices. According to various implementations, geometric elements within regions needing lithographic repair are examined to identify characteristics of the patterns formed by those geometric elements. Repair regions with common pattern characteristics then are categorized into classes. When a repair solution is determined for a selected repair region, that repair solution can be applied to the other repair regions in the same class as the selected repair region. In some implementations, the repair solution is applied to every instance of a repair region within the class. With still other implementations, however, the hierarchy of the layout design is examined to determine the hierarchical cell that includes all of the design elements of the selected repair region. The repair solution can then be applied to the design elements within that cell, propagating the repair throughout the design.

With some embodiments, the repair regions can be classified using one type of layout data for making repairs, and classified using another type of layout data for verifying that the repairs comply with various manufacturing requirements. For example, in some implementations, target layout data is used to classify the repair regions for repairing the hotspots. Enhanced layout data, such as layout data that has been processed using optical proximity correction, then is used to classify the repair regions for verifying that the corrected repair regions comply with various manufacturing requirements, such as mask rule check (MRC) rules.

### BRIEF DESCRIPTION OF THE DRAWINGS

FIGS. 1 and 2 illustrate components of a computer system that may be used to implement various embodiments of the disclosed technology.

FIGS. 3A, 3B, and 4A-4D illustrate an optical proximity correction process.

FIG. 5 illustrates an example of a hotspot repair tool that may be employed to repair hotspots in a layout design.

FIG. 6 illustrates a process for repairing hotspots in layout design data.

FIG. 7 illustrates a hot spot marker and the various regions making up a repair region defined around that hot spot marker.

FIG. 8 illustrates an example of repair regions overlapping only through their respective visible regions.

FIG. 9 illustrates an example of repair regions overlapping through their context and core regions.

FIGS. 10A and 12A, and 10B and 12B, respectively, illustrate different examples of repair regions containing the geometric element portions.

FIGS. 11A-11H illustrate a geometric element pattern and the various rotation and reflection transformations that may be applied to the pattern.

FIG. 13 shows an example of a pattern of geometric element features (that has been transformed about a pivot location.

FIG. 14 illustrates how repair regions can be organized into classes using a table.

### DETAILED DESCRIPTION

### Illustrative Operating Environment

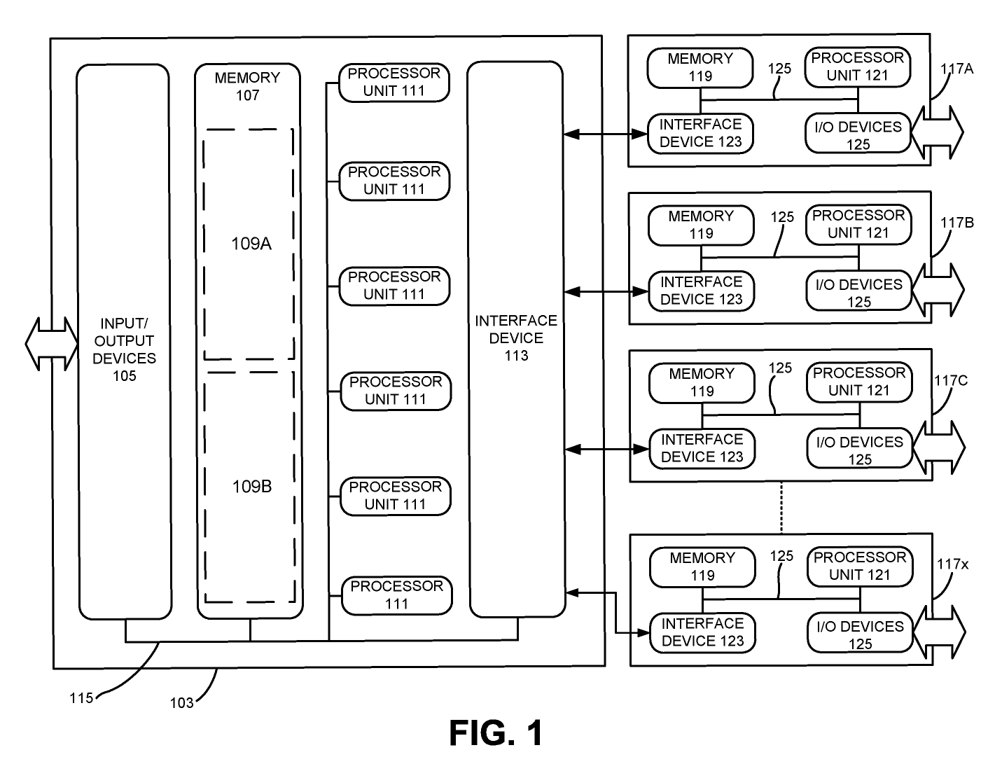

The execution of various electronic design automation processes described herein may be implemented using computer-executable software instructions executed by one or more programmable computing devices. Because these processes may be implemented using software instructions, the components and operation of a generic programmable computer system on which various embodiments of these processes may be employed will first be described. Further, because of the complexity of some electronic design automation processes and the large size of many circuit designs, various electronic design automation tools are configured to operate on a computing system capable of simultaneously running multiple processing threads. The components and operation of a computer system having a host or master computer and one or more remote or slave computers therefore will be described with reference to FIG. 1. This operating environment is only one example of a suitable operating environment, however, and is not intended to suggest any limitation as to the scope of use or functionality of any implementations of the invention.

In FIG. 1, the computer system 101 includes a master computer 103. In the illustrated example, the master computer 103 is a multi-processor computer that includes a plurality of input and output devices 105 and a memory 107. The input and output devices 105 may include any device for receiving input data from or providing output data to a user. The input devices may include, for example, a keyboard, microphone, scanner or pointing device for receiving input from a user. The output devices may then include a display monitor, speaker, printer or tactile feedback device. These devices and their connections are well known in the art, and thus will not be discussed at length here.

The memory 107 may similarly be implemented using any combination of computer readable media that can be accessed by the master computer 103. The computer readable media may include, for example, microcircuit memory devices such as read-write memory (RAM), read-only memory (ROM), electronically erasable and programmable read-only memory (EEPROM) or flash memory microcircuit devices, CD-ROM disks, digital video disks (DVD), or other optical storage devices. The computer readable media may also include magnetic cassettes, magnetic tapes, magnetic disks or other magnetic storage devices, punched media, holographic storage devices, or any other non-transitory storage medium that can be used to store desired information. As used herein, the term “non-transitory” refers to the ability to store information for subsequent retrieval at a desired time, as opposed to propagating electromagnetic signals.

As will be discussed in detail below, the master computer 103 runs a software application for performing one or more operations according to various examples of the invention. Accordingly, the memory 107 stores software instructions 109A that, when executed, will implement a software application for performing one or more operations. The memory 107 also stores data 109B to be used with the software application. In the illustrated embodiment, the data 109B contains process data that the software application uses to perform the operations, at least some of which may be parallel.

The master computer 103 also includes a plurality of processor units 111 and an interface device 113. The processor units 111 may be any type of processor device that can be programmed to execute the software instructions 109A, but will conventionally be a microprocessor device. For example, one or more of the processor units 111 may be a commercially generic programmable microprocessor, such as Intel® Pentium® or Xeon™ microprocessors, Advanced Micro Devices Athlon™ microprocessors or Motorola 68K/Coldfire® microprocessors. Alternately or additionally, one or more of the processor units 111 may be a custom-manufactured processor, such as a microprocessor designed to optimally perform specific types of mathematical operations. The interface device 113, the processor units 111, the memory 107 and the input/output devices 105 are connected together by a bus 115.

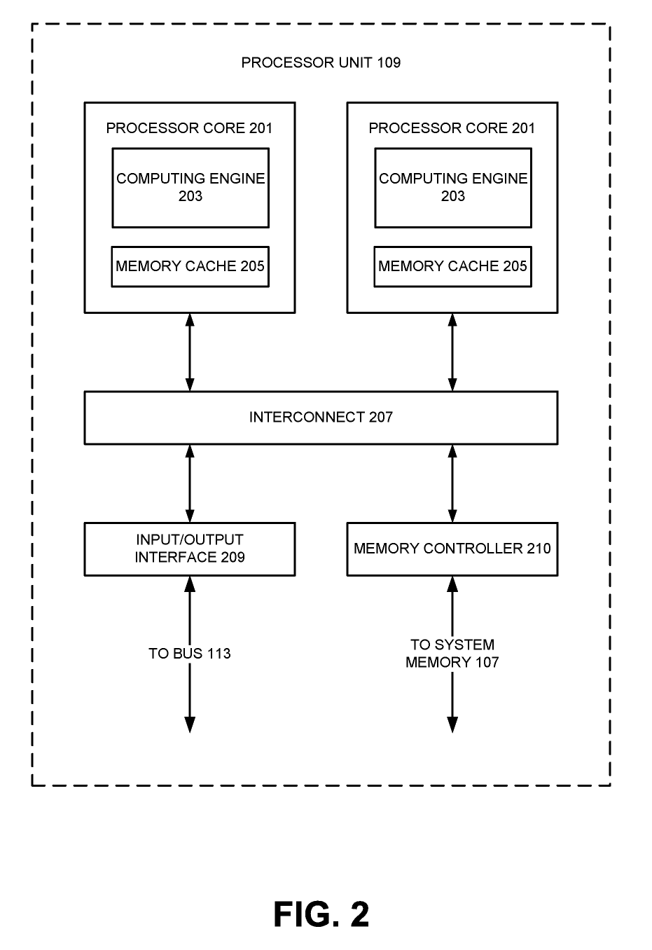

With some implementations of the invention, the master computing device 103 may employ one or more processing units 111 having more than one processor core. Accordingly, FIG. 2 illustrates an example of a multi-core processor unit 111 that may be employed with various embodiments of the invention. As seen in this figure, the processor unit 111 includes a plurality of processor cores 201. Each processor core 201 includes a computing engine 203 and a memory cache 205. As known to those of ordinary skill in the art, a computing engine contains logic devices for performing various computing functions, such as fetching software instructions and then performing the actions specified in the fetched instructions. These actions may include, for example, adding, subtracting, multiplying, and comparing numbers, performing logical operations such as AND, OR, NOR and XOR, and retrieving data. Each computing engine 203 may then use its corresponding memory cache 205 to quickly store and retrieve data and/or instructions for execution.

Each processor core 201 is connected to an interconnect 207. The particular construction of the interconnect 207 may vary depending upon the architecture of the processor unit 201. With some processor cores 201, such as the Cell microprocessor created by Sony Corporation, Toshiba Corporation and IBM Corporation, the interconnect 207 may be implemented as an interconnect bus. With other processor units 201, however, such as the Opteron™ and Athlon™ dual-core processors available from Advanced Micro Devices of Sunnyvale, Calif., the interconnect 207 may be implemented as a system request interface device. In any case, the processor cores 201 communicate through the interconnect 207 with an input/output interfaces 209 and a memory controller 211. The input/output interface 209 provides a communication interface between the processor unit 201 and the bus 115. Similarly, the memory controller 211 controls the exchange of information between the processor unit 201 and the system memory 107. With some implementations of the invention, the processor units 201 may include additional components, such as a high-level cache memory accessible shared by the processor cores 201.

While FIG. 2 shows one illustration of a processor unit 201 that may be employed by some embodiments of the invention, it should be appreciated that this illustration is representative only, and is not intended to be limiting. It also should be appreciated that, with some implementations, a multi-core processor unit 111 can be used in lieu of multiple, separate processor units 111. For example, rather than employing six separate processor units 111, an alternate implementation of the computing system 101 may employ a single processor unit 111 having six cores, two multi-core processor units each having three cores, a multi-core processor unit 111 with four cores together with two separate single-core processor units 111, etc.

Returning now to FIG. 1, the interface device 113 allows the master computer 103 to communicate with the slave computers 117A, 1157, 117C . . . 117x through a communication interface. The communication interface may be any suitable type of interface including, for example, a conventional wired network connection or an optically transmissive wired network connection. The communication interface may also be a wireless connection, such as a wireless optical connection, a radio frequency connection, an infrared connection, or even an acoustic connection. The interface device 113 translates data and control signals from the master computer 103 and each of the slave computers 117 into network messages according to one or more communication protocols, such as the transmission control protocol (TCP), the user datagram protocol (UDP), and the Internet protocol (IP). These and other conventional communication protocols are well known in the art, and thus will not be discussed here in more detail.

Each slave computer 117 may include a memory 119, a processor unit 121, an interface device 122, and, optionally, one more input/output devices 125 connected together by a system bus 127. As with the master computer 103, the optional input/output devices 125 for the slave computers 117 may include any conventional input or output devices, such as keyboards, pointing devices, microphones, display monitors, speakers, and printers. Similarly, the processor units 121 may be any type of conventional or custom-manufactured programmable processor device. For example, one or more of the processor units 121 may be commercially generic programmable microprocessors, such as Intel® Pentium® or Xeon™ microprocessors, Advanced Micro Devices Athlon™ microprocessors or Motorola 68K/Coldfire® microprocessors. Alternately, one or more of the processor units 121 may be custom-manufactured processors, such as microprocessors designed to optimally perform specific types of mathematical operations. Still further, one or more of the processor units 121 may have more than one core, as described with reference to FIG. 2 above. The memory 119 then may be implemented using any combination of the computer readable media discussed above. Like the interface device 113, the interface devices 123 allow the slave computers 117 to communicate with the master computer 103 over the communication interface.

In the illustrated example, the master computer 103 is a multi-processor unit computer with multiple processor units 111, while each slave computer 117 has a single processor unit 121. It should be noted, however, that alternate implementations of the technology may employ a master computer having single processor unit 111. Further, one or more of the slave computers 117 may have multiple processor units 121, depending upon their intended use, as previously discussed. Also, while only a single interface device 113 or 123 is illustrated for both the master computer 103 and the slave computers, it should be noted that, with alternate embodiments of the invention, either the computer 103, one or more of the slave computers 117, or some combination of both may use two or more different interface devices 113 or 123 for communicating over multiple communication interfaces.

With various examples of the computer system 101, the master computer 103 may be connected to one or more external data storage devices. These external data storage devices may be implemented using any combination of non-transitory computer readable media that can be accessed by the master computer 103. The computer readable media may include, for example, microcircuit memory devices such as read-write memory (RAM), read-only memory (ROM), electronically erasable and programmable read-only memory (EEPROM) or flash memory microcircuit devices, CD-ROM disks, digital video disks (DVD), or other optical storage devices. The computer readable media may also include magnetic cassettes, magnetic tapes, magnetic disks or other magnetic storage devices, punched media, holographic storage devices, or any other medium that can be used to store desired information. According to some implementations of the computer system 101, one or more of the slave computers 117 may alternately or additions be connected to one or more external non-transitory data storage devices. Typically, these external non-transitory data storage devices will include data storage devices that also are connected to the master computer 103, but they also may be different from any data storage devices accessible by the master computer 103.

It also should be appreciated that the description of the computer system 101 illustrated in FIG. 1 and FIG. 2 is provided as an example only, and it not intended to suggest any limitation as to the scope of use or functionality of various embodiments of the invention.

### Organization of Layout Design Data

As used herein, the term “design” is intended to encompass data describing an entire microdevice, such as an integrated circuit device or micro-electromechanical system (MEMS) device. This term also is intended to encompass a smaller group of data describing one or more components of an entire microdevice, however, such as a layer of an integrated circuit device, or even a portion of a layer of an integrated circuit device. Still further, the term “design” also is intended to encompass data describing more than one microdevice, such as data to be used to create a mask or reticle for simultaneously forming multiple microdevices on a single wafer. The layout design data may be in any desired format, such as, for example, the Graphic Data System II (GDSII) data format or the Open Artwork System Interchange Standard (OASIS) data format proposed by Semiconductor Equipment and Materials International (SEMI). Other formats include an open source format named Open Access, Milkyway by Synopsys, Inc., and EDDM by Mentor Graphics, Inc.

The design of a new integrated circuit may include the interconnection of millions of transistors, resistors, capacitors, or other electrical structures into logic circuits, memory circuits, programmable field arrays, and other circuit devices. In order to allow a computer to more easily create and analyze these large data structures (and to allow human users to better understand these data structures), they are often hierarchically organized into smaller data structures, typically referred to as “cells.” Thus, for a microprocessor or flash memory design, all of the transistors making up a memory circuit for storing a single bit may be categorized into a single “bit memory” cell. Rather than having to enumerate each transistor individually in the design, the group of transistors making up a single-bit memory circuit can thus collectively be referred to and manipulated as a single unit. Similarly, the design data describing a larger 16-bit memory register circuit can be categorized into a single cell. This higher level “register cell” might then include sixteen bit memory cells, together with the design data describing other miscellaneous circuitry, such as an input/output circuit for transferring data into and out of each of the bit memory cells. Similarly, the design data describing a 128 kB memory array can then be concisely described as a combination of only 64,000 register cells, together with the design data describing its own miscellaneous circuitry, such as an input/output circuit for transferring data into and out of each of the register cells. Of course, while the above-described example is of design data organized hierarchically based upon circuit structures, circuit design data may alternately or additionally be organized hierarchically according to any desired criteria including, for example, a geographic grid of regular or arbitrary dimensions (e.g., windows), a memory amount available for performing operations on the design data, design element density, etc.

### Layout Design Enhancement

In a photolithographic manufacturing process, electromagnetic radiation is transmitted through selectively transparent areas of a mask. The radiation passing through these transparent areas then irradiates desired portions of a layer of photoresistive material on the surface of a substrate. The mask in turn is created from layout design data describing the geometric features that should be manufactured on the semiconductor substrate in order to create the desired circuit. For example, if a transistor should have a rectangular gate region, then the layout design data will include a rectangle defining that gate region. This rectangle in the layout design data is then implemented in a mask for creating the rectangular gate region during the photolithographic manufacturing process.

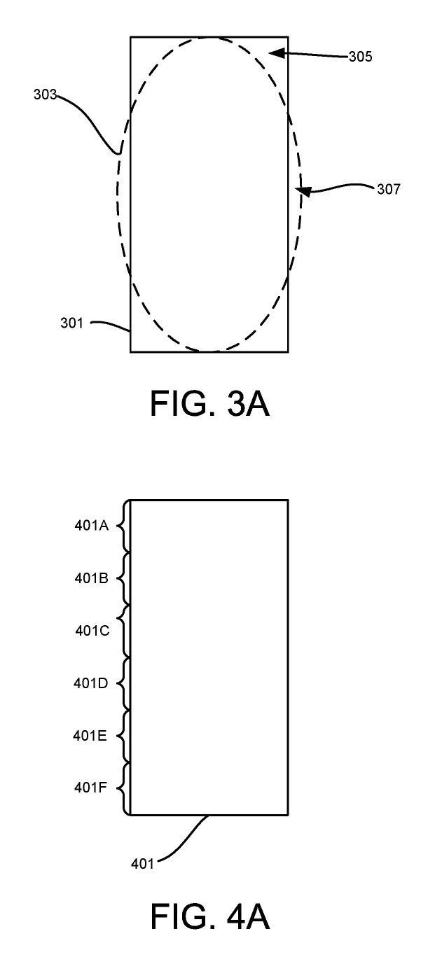

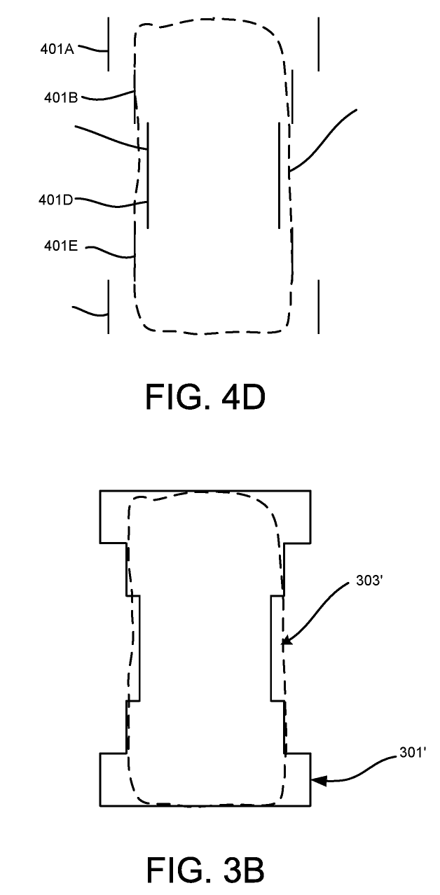

During a photolithographic process, optical effects will prevent the shapes defined by the mask from being faithfully imaged onto the substrate. Diffractive effects, for example, may distort the image produced by a mask. Moreover, these distortions become more pronounced as the images produced by the mask become smaller relative to the wavelength of radiation used in the photolithographic process. Thus, the rectangular mask feature 301 illustrated in FIG. 3 may produce only the image 303. As seen in this figure, the image 303 is substantially narrower in the corners (e.g., corner 305) than the ideal rectangular shape intended by the mask feature 301. Likewise, the image 303 may have areas (e.g., 307) that extend beyond the ideal rectangular shape intended by the mask feature 301. The intended shape or feature often is referred to as the “target” shape or the “target” image, and typically corresponds to the initial layout design data or “target” layout design data. The image created by employing the mask in a photolithographic process is often then referred to as the printed image.

To correct for these optical distortions, many circuit designers will attempt to enhance the initial layout design data to improve the images that will be produced by the resulting mask during the photolithographic process. Some of these enhancements are applied to improve the resolution of the printed image. These enhancements are sometimes generally referred to as resolution enhancement techniques. Still other enhancements are applied to compensate for distortions inherent in the manufacturing process. One such enhancement is known as optical proximity correction (OPC).

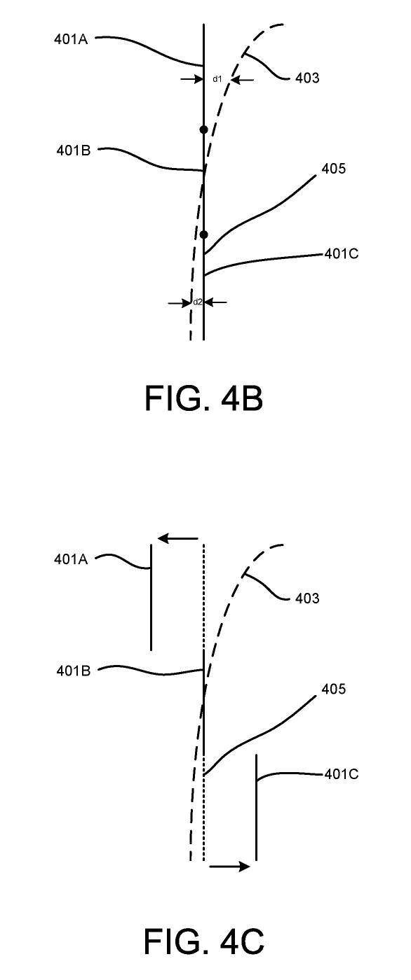

For example, some IC designers will employ an optical proximity correction (OPC) process on the target layout design data to better control the amplitude of the radiation transmitted by the mask at specific locations. In a conventional optical proximity correction process, the edges of the geometric elements in the design are fragmented. Thus, as shown in FIG. 4A, an edge of the geometric element 401 used to create the mask feature 301 may be fragmented into edge fragments 401A-401F. The size of the edge fragments in a given layout design depends upon the optical proximity correction process parameters, often referred to as the optical proximity correction recipe. The “recipe” specifies the size of the edge fragments. Accordingly, not all edges within a layout design are fragmented in every optical proximity correction process.

With some optical proximity correction process techniques, the printed image is simulated. That is, the photolithographic process is simulated in order to produce a simulated printed image, such as the example image 303 shown in FIG. 3. This simulated image is compared to the target image. Typically, this comparison is done at each edge fragment. For example, as shown in FIG. 4B, the target image is a distance d1 away from the simulated printed image at the edge fragment 401A, the target image is a distance d2 away from the simulated printed image at the edge fragment 401C, while the target image intersects the simulated printed image at the edge fragment 401B. The distances between the target image and the simulated printed image are often referred to as the edge placement error (EPE). Accordingly, in most conventional optical proximity correction processes, each edge fragment (or unfragmented edge) has an associated edge placement error.

Next, the edge fragments are individually moved in order to improve the resolution of the simulated printed image for the resulting mask. For example, as shown in FIG. 4C, the edge fragment 401A is displaced in a direction away from the geometric element 401, in an effort to widen the corresponding portion of the image that would be produced by the resulting mask. Similarly, the edge fragment 401C is displaced in a direction toward the geometric element 401, in an effort to narrow the corresponding portion of the image that would be produced by the resulting mask. The image that would be produced by a mask using the displaced edge fragments then is simulated. The new simulated image is compared with the target image, and the edge placement errors for each edge fragment are computed.

This process of moving the edge fragments, simulating the image that would be produced using the moved edge fragments, and comparing the simulated image to the target image may be repeated a number of times. Each cycle of moving edge fragments and comparing the new simulated image to the target image is referred to as an iteration of the optical proximity correction process. Typically, edge fragments moved during a given iteration, and the distance the edge fragments are displaced, are determined based upon the edge placement error. For example, an optical proximity correction process may move the edge fragments some factor of the edge placement error away from the simulated printed image. Alternately, each edge fragment could be displaced the same distance during a given iteration. The specific parameters than control edge fragment movement is dependent upon the tool used to implement the optical proximity correction process and the optical proximity correction process recipe.

Typically, these steps will be repeated until the simulated image is sufficiently similar to the target image (e.g., both d1 and d2 are smaller than a threshold value), or until it is determined that the displacements of the edge fragments already have converged on locations where no further movement of the edge fragments will improve the simulated image, as shown in FIG. 4D. Once the final positions of the edge fragments are determined in the layout design data, as shown in FIG. 4D, a modified mask feature 301′ can be created from the corrected layout design data. As shown in FIG. 3B, the image 303′ produced by a mask created from the enhanced layout design features 301′ should more closely correspond to the target image than the target layout design features 301.

Layout design enhancement techniques, such as optical proximity correction, typically are applied to a large portion or the entirety of a layout design. While these enhancement techniques generally improve the manufacturability of a layout design, they also may introduce errors into the design. For example, a broadly-applied computational lithography process could create local errors for a variety of reasons, such as the OPC recipe not being tuned well, mask rule check (MRC) errors restricting the corrective movements an OPC process, convergence not being achieved due to process window constraints that are too aggressive, and software problems such as tiling border issues. Accordingly, once a layout design has been enhanced, it typically is analyzed with a verification tool to determine if there are any configurations of geometric element features where the enhancements have either negatively impacted the manufacturability of the layout design or not improved an existing undesirable configuration of geometric element features. These undesired configurations, sometimes referred to as “hotspots,” can then be addressed locally using conventional computational lithography technique to improve the manufacturability of the design in those areas.

This local printability enhancement (LPE) approach has proved useful in applying computational lithography to efficiently repair hotspots without having to revise the entire design. Although such a localized design refinement on a relatively small number of hotspots can be quite useful, in reality a layout design may have a large number of hotspots, thereby requiring a design tool to process a large volume of data to repair the hotspots. In the case of designs for memory circuits in particular, the number of hotspots in highly repetitive patterns can be enormous.

### Hotspot Repair Tool

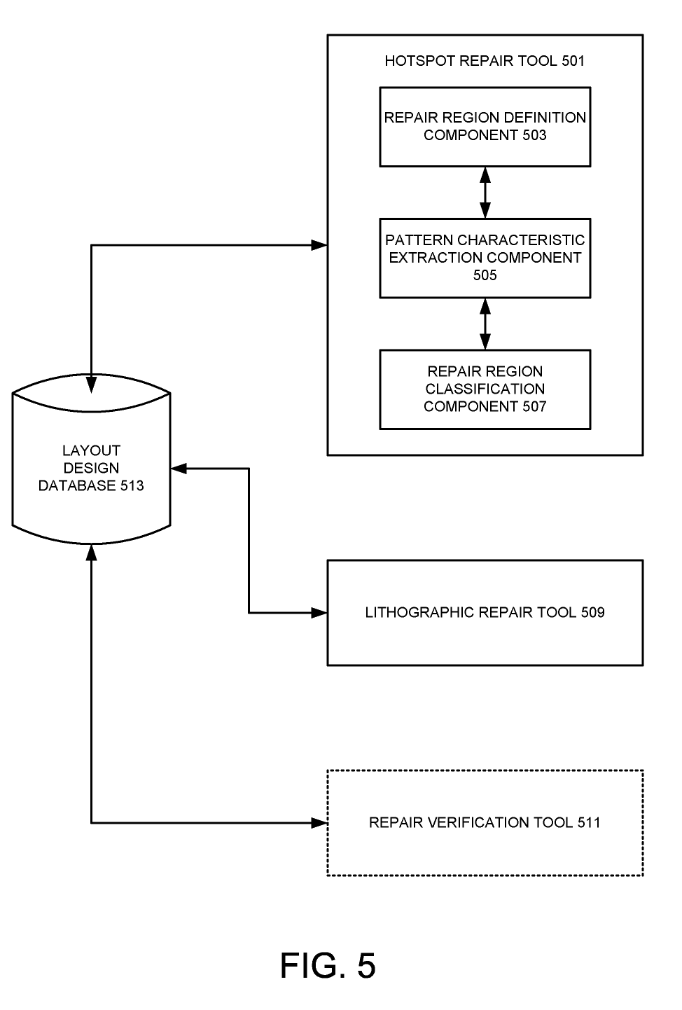

FIG. 5 illustrates an example of a hotspot repair tool 501 that may be employed to efficiently repair hotspots in a layout design. As seen in this figure, the hotspot repair tool 501 includes a repair region definition component 503, a pattern characteristic extraction component 505, and a repair region classification component 507. As will be explained in more detail below, the hotspot repair tool 501 may be employed in conjunction with a lithographic repair tool 509, an optional repair verification tool 511, and a layout design database 513.

Various examples of the hotspot repair tool 501, the lithographic repair tool 509 or the repair verification tool 511 may be embodied by a single or multiprocessor computing system, such as the computing system 101 illustrated in FIG. 1. Accordingly, one or more components of each of the repair region definition component 503, the pattern characteristic extraction component 505, the repair region classification component 507, the lithographic repair tool 509 or the repair verification tool 511 may be embodied using one or more processors in a multiprocessor computing system's master computer, such as the master computer 103, one or more servant computers in a multiprocessor computing system, such as the servant computers 117, or some combination of both executing the appropriate software instructions. Of course, some examples of the hotspot repair tool 501 or lithographic repair tool 509 may be implemented by, for example, one or more computer-readable devices having such software instructions stored thereon in a non-transitory manner, that is, stored over a period of time such that they may be retrieved for use at any arbitrary point during that period of time.

It also should be appreciated that, while the repair region definition component 503, the pattern characteristic extraction component 505 and the repair region classification component 507 are shown as separate units in FIG. 5, a single servant computer (or a single processor within a master computer) may be used to embody two or all three of these components at different times, or aspects of two or three of these components at different times. In addition, the hotspot repair tool 501 is shown in the illustrated example as being separate from the lithographic repair tool 509 and the repair verification tool 511. With various embodiments of the hotspot repair tool 501, however, some or all of the functionality of the lithographic repair tool 509, the repair verification tool 511, or both may be incorporated into the hotspot repair tool 501.

Still further, various examples of the hotspot repair tool 501, the lithographic repair tool 509 or the repair verification tool 511 may be embodied by a hardware device, such as a field programmable gate array (FPGA) system configured to implement the functionality of the hotspot repair tool 501. As will be appreciated by those of ordinary skill in the art, conventional field programmable gate arrays contain memory and programmable logic blocks that can be configured to operate as simple logic gates (such as AND and XOR gates) or to perform more complex combinational functions. Field programmable gate arrays also contain a hierarchy of reconfigurable interconnects that allow the blocks to be wired together in different configurations. Thus, some examples of the hotspot repair tool 501 may be embodied by using field programmable gate arrays configured to have combinatorial logic circuits that perform the functionality of the hotspot repair tool 501, the lithographic repair tool 509, or the repair verification tool 511 as described in more detail below. Still further, some examples of the hotspot repair tool 501, the lithographic repair tool 509, the repair verification tool 511 or some combination thereof may be embodied by an application-specific integrated circuit (ASIC) configured to perform aspects of the functionality of those tools.

The layout design database 513 may be implemented using any non-transitory storage device operable with the hotspot repair tool 501, the lithographic repair tool 509 and, where employed, the repair verification tool 511. For example, the layout design database 513 may be implemented by microcircuit memory devices, such as read-write memory (RAM), read-only memory (ROM), electronically erasable and programmable read-only memory (EEPROM) or flash memory microcircuit devices, CD-ROM disks, digital video disks (DVD), or other optical storage devices. The layout design database 513 may also be implemented by magnetic cassettes, magnetic tapes, magnetic disks or other magnetic storage devices, punched media, holographic storage devices, or any combination of the foregoing devices.

As will be appreciated by those of ordinary skill in the art, the number of hotspots in a typical microdevice design may be in the hundreds of thousands. Accordingly, the classification, repair and verification of hotspots as described herein for a typical microdevice design cannot be practically accomplished without employing both machine-based analysis and machine-based information storage. Thus, various implementations of the tools and techniques described herein must be implemented using a computer or other computational device, such as the field programmable gate array device described above, together with an electrical or electromechanical memory storage device.

As will be discussed in more detail below, the repair region definition component 503 defines repair regions in layout design data, that is, regions that need further enhancement to improve their manufacturability. After a repair region is identified, characteristics of the geometric elements in that repair regions are extracted by the pattern characteristic extraction component 505. Based upon the characteristics of their geometric elements, the repair regions are categorized into classes by the repair region classification component 507. After the repair region classification component 507 has classified the repair regions, the lithographic repair tool 509 will repair a representative repair region in each class. When the lithographic repair tool 509 repairs a representative repair region for a class, that same repair is applied to all of the repair regions for that class. This process is repeated until a representative repair region for each class has been repaired.

With various optional implementations, the repair verification tool 511 is employed to verify the repairs made by the lithographic repair tool 509. For example, with some embodiments, the repair verification tool 511 will verify the repairs made to a representative repair region in each class created by the repair region classification component 507. After the repair verification tool 511 has verified a representative repair region for a class, the same verification results are applied to all of the repair regions for that class. With some implementations, the same classes of repair regions will be used by both the lithographic repair tool 509 and the repair verification tool 511.

For still other implementations, however, the pattern characteristic extraction component 505 and the repair region classification component 507 will cooperate to create two groups of classes: a target group of classes based upon target layout design data, and an enhanced group of classes based upon enhanced layout design data. More particularly, the pattern characteristic extraction component 505 will identify characteristics of the target layout design data for the repair regions, and the repair region classification component 507 will categorize the repair regions into a first set of classes based upon those target layout design data characteristics. The pattern characteristic extraction component 505 also will identify characteristics of the enhanced layout design data for the repair regions, and the repair region classification component 507 will categorize the repair regions into a second set of classes based upon those enhanced layout design data characteristics. The lithographic repair tool 509 will then employ the target classes created using the target layout design data, while the repair verification tool 511 will employ the enhanced classes created using the enhanced layout design data.

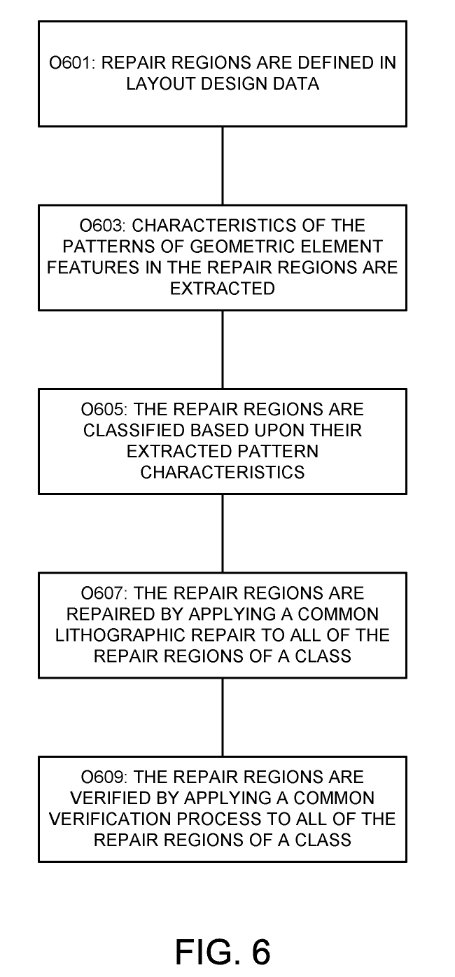

FIG. 6 illustrates a process for repairing hotspots in layout design data. While different aspects of this process will be described with reference to the hotspot repair tool 501 shown in FIG. 5, it should be appreciated that various implementations of this method may be implemented without using the specific hotspot repair tool 501. Similarly, the hotspot repair tool 501 may be used to implement alternate methods for repairing hotspots in layout design data.

### Identification of Repair Regions

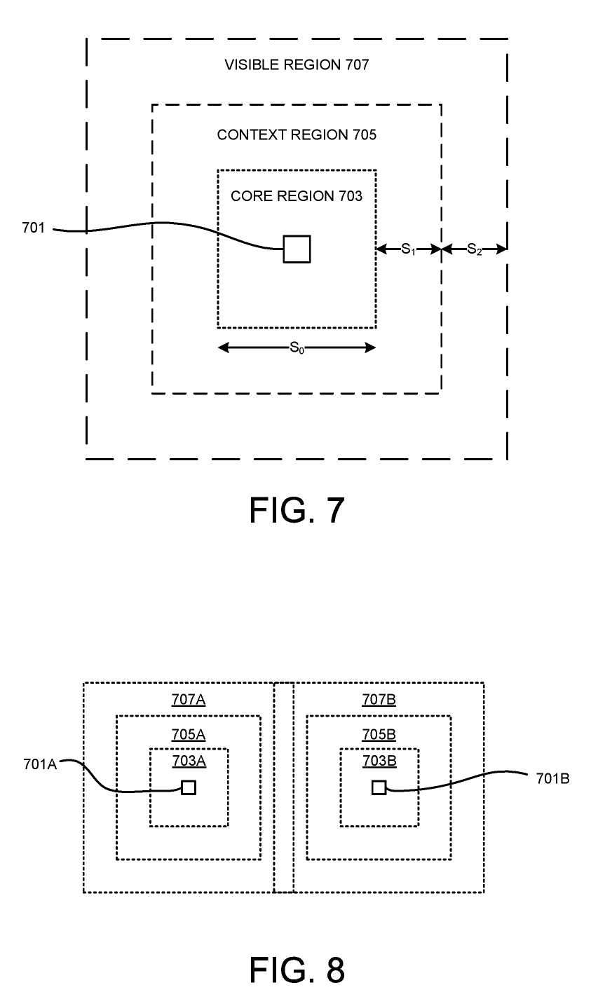

Turning now to FIG. 6, in operation 601 the repair region definition component 503 defines repair regions in layout design data. The layout design data, which may be obtained from the layout design database 511, can be for a design, such as a design for an integrated circuit, a portion of an integrated circuit, or multiple integrated circuits. With various implementations, the repair region definition component 503 defines repair regions based upon a marker in the layout design data created to identify a hot spot area. For example, FIG. 7 illustrates a hot spot marker 701 and various regions making up a repair region defined around that hot spot marker 701. As shown in this figure, the hot spot marker 701 indicates a “hotspot”—a configuration of geometric element features that negatively impact the manufacturability of the layout design data.

With some implementations, the hotspot markers 701 may already be included in the layout design data. For still other implementations, the hotspot markers 701 may be added to layout design data through the use of a layout verification tool, such as the repair verification tool 511. The layout verification tool may analyze the geometric elements in the layout design data to confirm that its geometric elements comply with predetermined rules, such as placement and spacing rules. This type of verification process is sometimes referred to as a design rule check (DRC) process. Alternately or additionally, the layout verification tool may simulate the printing of the layout design data during a lithographic manufacturing process. If an area of the layout design data contains a rule violation or could not be accurately printed during a lithographic manufacturing process, then the layout verification tool will modify the layout design data to include hotspot markers identifying those areas. Examples of such layout verification tools include the Calibre® family of verification tools (including Calibre® DRC, Calibre® YieldEnhancer, and Calibre® LFD) available from Mentor Graphics® Corporation of Wilsonville, Oreg., and the Litho Physical Analyzer available from Cadence® Design Systems of San Jose, Calif.

Typically, a hotspot marker 701 will be a geometric element (in this example, a square) that has been added to the layout design data. For example, the hotspot marker 701 may be created as geometric element in a derived layer of the layout design data, with the location (such as a coordinates of a vertex) of the geometric element listed in a table of hotspot locations or otherwise retrievable or determinable by the repair region definition component 503.

With various implementations, the repair region definition component 503 defines a repair region around a hotspot marker 701. As shown in FIG. 7, the repair region may include a core region 703, a context region 705, and a visible region 707. The core region 703 denotes the area where most of the changes to the layout design data are made to repair the undesired configuration of geometric elements associated with the hotspot marker 701. Typically, the core region 703 will be centered on the hotspot marker 701 and have a width S₀, as shown in FIG. 7. The width S₀ may be selected to match or approximate the optical radius OD/2, where OD is the optical diameter (and, roughly speaking, the range of optical interference from the center of the hotspot marker). Of course, with still other implementations, the width S₀ may be selected to have another value, such as to match or approximate the optical diameter OD. In a typical setting, OD≈1.28 μm, so OD/2≈0.64 μm.

The context region 705 surrounds the core region 703 by a depth of S₁, and the visible region 707 surrounds the context region 705 by a depth of S₃, as shown in FIG. 7. As will be appreciated by those of ordinary skill in the art, when the hotspot is analyzed for repair, the printability of geographic element features within the core region 703 will be simulated. As will be appreciated by those of ordinary skill in the art, however, the impact of the geometric element features around the core region 703 should be considered to accurately determine the printability of geographic element features within the core region 703. The visible region 707 defines the geometric element features that should be considered when determining the printability of the geometric element features within the core region 703. With some implementations, it is preferable that the impact of possible geometrical modifications in the core region 703 should not reach the geometric elements in the visible region 707. Accordingly, the width S₁ also may be selected to match or approximate the optical radius OD/2.

After the layout design data has been modified to correct the hotspot associated with the hotspot marker 701, the modified layout design data must be added or “stitched” back into the layout design to replace the layout design data creating the hotspot. The context region 705 provides the room for a smooth transition between the modified geometric element features in the core region 703 and the unmodified geometric element features in the visible region 707. With some implementations, it is preferable that the repair region is contained in a small area. Further, possible geometrical modifications in the core and context regions should not have an impact on the lithography image produced outside the visible region, in order for the repair results to be consistent with the rest of the layout design data. Accordingly, with various implementations, the width S₂ may be selected to match or approximate the optical radius OD/2 with some additional added slack value, that is, S₂=OD/2+slack. The slack value may be, for example, 0.2 μm, and is provided primarily to ensure that possible geometrical modifications in the core and context regions should not have an impact on the lithography image produced outside the visible region.

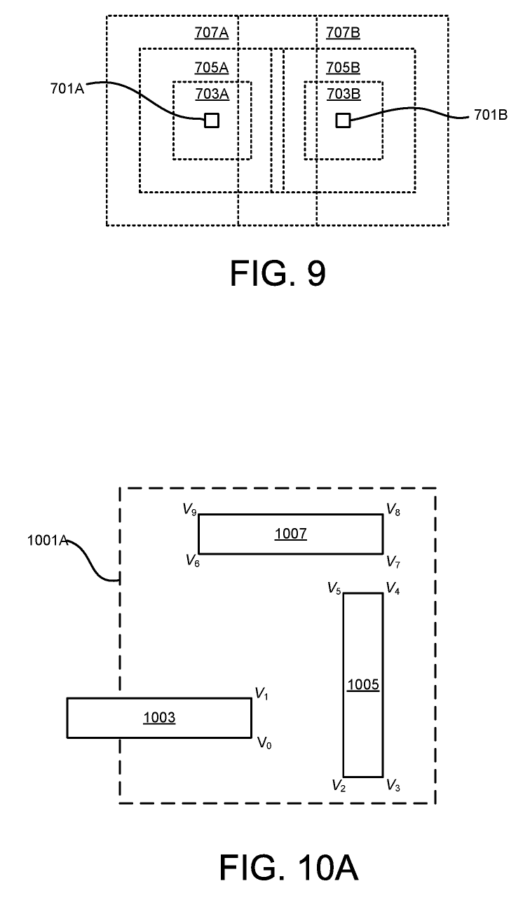

In some situations, two or more hotspot markers 701 may be so close together that their corresponding repair regions overlap. For example, the overlapping repair regions may overlap with one another only through the visible regions 707, as shown in FIG. 8. With some implementations, the repair region definition component 503 will define these instances of overlapping repair regions as separate repair regions. This approach keeps the repair regions as small as possible for analysis, and increases the chance of matching the patterns of geometric elements in these regions with smaller repair regions. With some implementations, however, the repair region definition component 503 will merge repair regions that overlap with one another through the core regions 703 or context regions 705, as shown in FIG. 9. When multiple repair regions are merged, the pattern of geometric elements will be analyzed (as discussed in more detail below) based upon the entirety of the merged regions.

### Classification of Repair Regions

As will be discussed in more detail below, the hotspot repair tool 501 classifies repair regions based upon the geometric element features within the repair regions. That is, repair regions that share the same pattern of geometric element features are categorized together into a single class. Thus, with various implementations, the pattern characteristic extraction component 505 will extract characteristics of the patterns of geometric element features in the repair regions. Based upon those characteristics, the repair region classification component 507 determines which repair regions share the same patterns of geometric element features, and categorizes those repair regions having the same pattern into a common class.

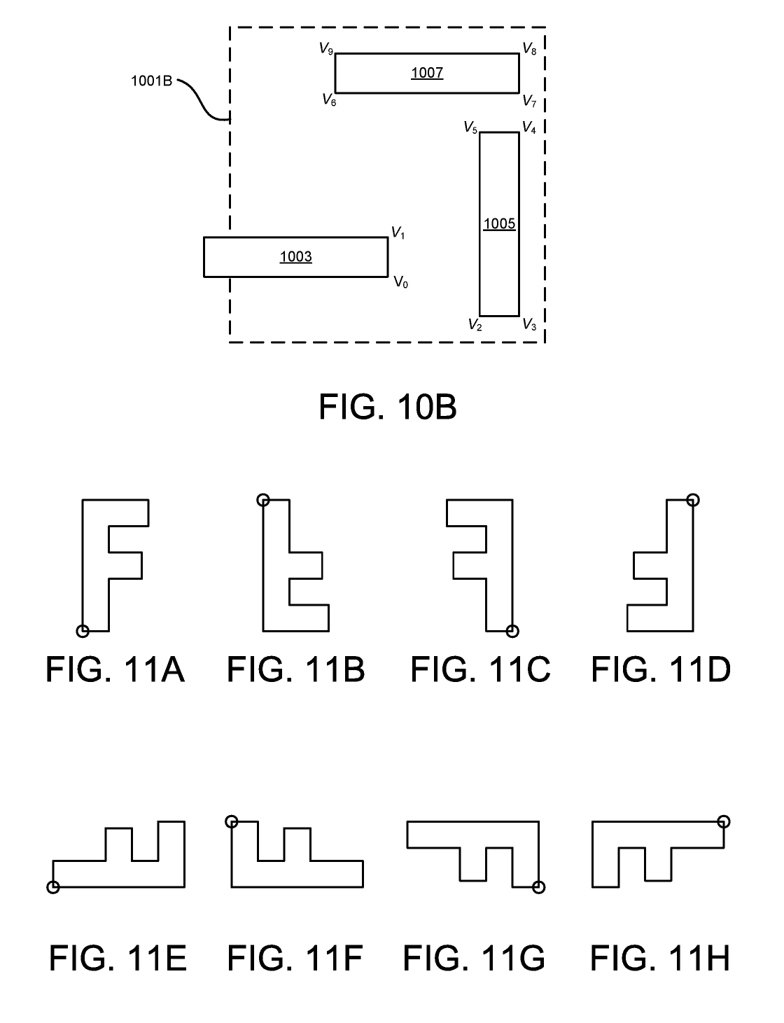

Accordingly, in operation 603, the pattern characteristic extraction component 505 extracts characteristics of the patterns of geometric element features in the repair regions that can be used to determine if two repair regions share the same pattern. It is desirable to recognize the repetition of a pattern of geometric elements in different repair regions even if the positions of the hotspot markers 701 relative to the repeated patterns differ slightly between the repair regions. With various implementations, the pattern characteristics are defined to include a collection of the geometric element vertices inside the repair region (that is, the core region 703, the context region 705, and the visible region 707). The core region 703). For example, FIG. 10A illustrates a repair region 1001A containing a portion of a geometric element 1003 and the entirety of the geometric elements 1005 and 1007. Geometric element 1003 includes vertices V₀ and V₁ within the repair region 1001A. Similarly, geometric element 1005 has vertices V₂, V₃, V₄ and V₅ within the repair region 1001A, while the geometric element 1007 has vertices V₆, V₇, V₈ and V₉ within the repair region 1001A.

With various embodiments, the vertices outside the repair region are ignored. Also, if the edge of a geometric element cuts through the border of a repair region, vertices at the border are not considered as part of the pattern characteristics. Each geometric element can be identified based on a unique geometric element number, through which the pattern characteristic extraction component 505 can keep track of which vertex belongs to which geometric element. Furthermore, the vertices that belong to the same geometric element can be ordered based on a specified geometric element orientation. For example, for implementations that employ a counterclockwise geometric element orientation, if there are two vertices Vₓ and V_{y} in this order, the interior side of the geometric element resides on the “left” side of the directed edge defined from vertices Vₓ and V_{y}.

As previously noted, even if two identical patterns have shifted slightly relative to their respective repair regions, using the vertices inside the repair region as pattern characteristics typically will provide the same characteristics for both repair regions. For example, FIG. 10A shows an example of geometric elements 1003-1007 that are partially or entirely enclosed within a repair region 1001. FIG. 10B illustrates another instance of the geometric elements 1003-1007 that are partially or entirely enclosed within a different repair region 1001B. While the geometric elements 1003-1007 provide the same pattern of geometric element features for both regions 1001A and 1001B, they are translated (i.e., shifted) in relation to their respective repair regions. This situation may occur, for example, when hotspot markers are placed in slightly different locations relative to a hotspot. Even with this relative translation, the pattern characteristics of the geometric elements 1003-1007 in FIG. 10A will be the same as the pattern characteristics of the geometric elements 1003-1007 in FIG. 10B, so both repair regions 1001A and 1001B will have the same pattern characteristics.

In operation 605, the repair region classification component 507 classifies the repair regions based upon their extracted pattern characteristics. To make this classification, the repair region classification component 507 determines if a selected repair region shares the same pattern of geometric element features as a previously-analyzed repair region.

In order to determine whether multiple geometric patterns are the same and classify them as such, it is convenient to have some compact metric to evaluate the characteristics of the geometric patterns to make the determination. With various implementations of the repair region classification component 507, the metric is transformation invariant for those identical patterns that only differ by a congruent transformation (that is, are translated (shifted), rotated or reflected). For example, FIG. 11A shows a geometric element pattern created by a single geometric element having an “F”-shape. FIGS. 11B-11H then illustrate the various rotation and reflection transformations that may be applied to the pattern in FIG. 11A about a pivot point marked with an “o” in each figure. More particularly, FIGS. 11B and 11C illustrate the geometric pattern reflected about the x-axis (a “reflect x” transformation) and reflected about the y-axis (a “reflect-y” transformation), respectively. FIG. 11D then illustrates a 180° rotation, while FIG. 11E illustrates a “reflect 45°” transformation. FIGS. 11F and 11G show a 90° rotation and a −90° rotation, respectively, while FIG. 11H illustrates a “reflect −45°” transformation. As can be seen from FIGS. 11B-11H, each illustrates the same geometric pattern shown in FIG. 11A but with a different transformation. Various implementations of the repair region classification component 507 employ a metric for classifying the patterns of geometric elements that will recognize instances of the same pattern regardless of whether an instance of the pattern has been transformed.

One such invariant metric that may be employed by implementations of the repair region classification component 507 is the number of the polygons in the window defined by the repair region. Another metric is the number of the internal vertices in the window. These metrics are useful, but there always a chance that different sets of geometric elements can have the same number of geometric elements and the same number of the internal vertices, but that their features will create different patterns.

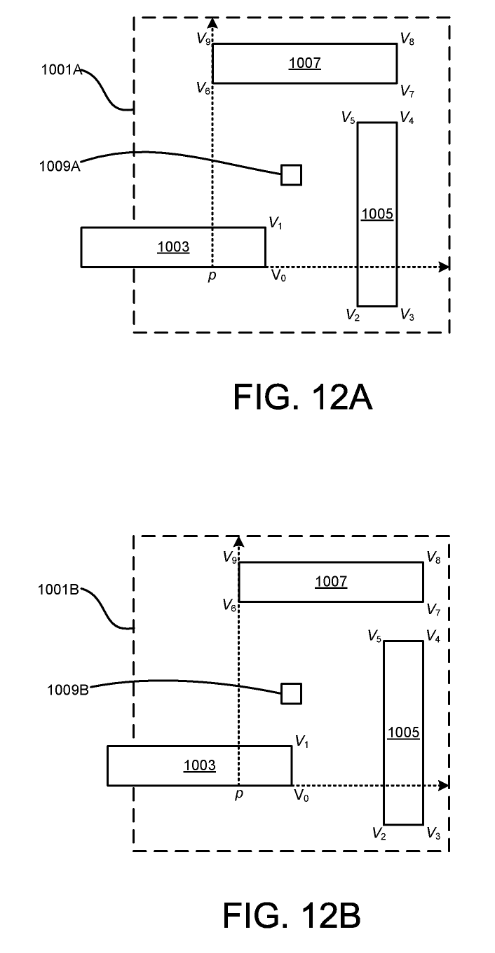

Accordingly, various implementations of the repair region classification component 507 employ the sum of all relative internal vertices, or the internal vertex sum, as follows:

$${\sum }_{i = 1}^{N - 1} ( {x}_{i} - {x}_{pivot} , {y}_{i} - {y}_{pivot} ) \qquad ( 1 )$$

where (xᵢ,yᵢ) is the coordinate of internal vertex υᵢ and N is the number of vertices. The precise definition of (xₚᵢᵥₒₜ,yₚᵢᵥₒₜ) is transform-dependent, but the effectiveness of this metric is demonstrated by an example where two sets of pattern of geometric element features differ only by some translation, such as the translation between the geometric elements 1003-1007 illustrated in FIG. 10A and the same geometric elements 1003-1007 shown in FIG. 10B. In this example, the pivot location, p, for each arrangement is defined as the lower left corner of the minimum extent that covers all internal vertices as shown in FIGS. 12A and 12B (which correspond to FIGS. 10A and 10B, respectively). If V is the set of the internal vertices {υᵢ}, the pivot in this case is defined as follows:

xₚᵢᵥₒₜ=min{υ_{i,x})}

yₚᵢᵥₒₜ=min{υ_{i,y})}

for the x and y coordinates, respectively. With the pivot point p and a given vertex defined, respectively, as

p=(xₚᵢᵥₒₜ,yₚᵢᵥₒₜ)

υi=(xᵢ,yᵢ)

so

$${\sum }_{i ∈ v}^{ } {x}_{i} - {x}_{pivot} , {y}_{i} - {y}_{pivot} = invariant$$

Thus, as shown in FIGS. 12A and 12B, when the coordinates are defined relative to the respective pivots p, the relative coordinates are identical between the two, so the sum of all relative internal vertices likewise are identical. Based on this metric, slight differences in the marker positions, which result in slight differences in the window positions relative to the repeated patterns, will not affect the sameness of the different sets of the relative coordinates.

This metric, based upon the sum of all relative internal vertices, is likewise useful in identifying identical patterns of geometric features when one set of the features are transformed (that is, translated, rotated, or reflected) with respect to the other set of features. Because the internal vertex sum is a linear summation, a transformation coefficient can easily be applied, as follows:

$$T {\sum }_{i = 1}^{N - 1} ( {x}_{i} - {x}_{pivot} , {y}_{i} - {y}_{pivot} ) \qquad ( 2 )$$

where T is the transformation matrix appropriate for the transformation between the two sets of geometric element features.

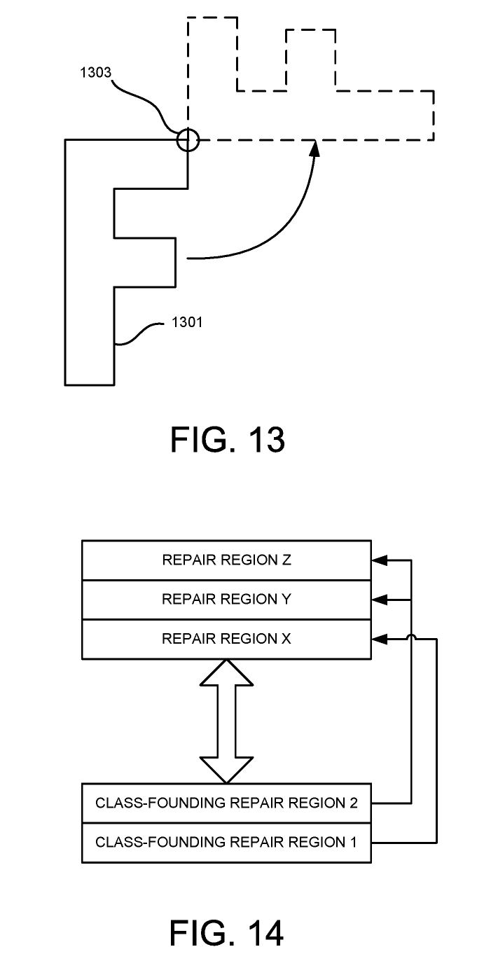

FIG. 13 shows an example of a pattern of geometric element features (in this example, the geometric element 1301) that has been transformed about a pivot location 1303. With this example, the upper left corner (as viewed facing the page) is used as the pivot location 1303, and a 90° rotation transformation is applied to the geometric element 1301. Other than the 90° rotation transformation, the only other possible difference between the two patterns of geometric element features is a translation transformation. Thus, using the 90° rotation transformation matrix in the formula above, the relative coordinates between the two pattern arrangements are identical.

When comparing two sets of patterns, it is initially unknown which transformation to apply to evaluate the equivalence of the two patterns. However, as there are only eight basic congruent, non-translation transformations to consider, various implementations of the repair region classification component 507 simply evaluate all eight transformation possibilities to identify matching patterns. Because of the linearity of the expression, the sum of formula (1), above, can be split into two terms:

$${\sum }_{i = 1}^{N - 1} ( {x}_{i} , {y}_{i} ) - N ( {x}_{pivot} , {y}_{pivot} ) \qquad ( 3 )$$

As seen above, the first term can be calculated without the knowledge of the correct pivot coordinates. The second term must be calculated with the correct pivot coordinates, but the computation of this term is a simple matter of one multiplication. To evaluate all cases of the eight basic congruent, non-translation transformations, various embodiments of the repair region classification component 507 reuses the first term evaluation, selects the correct pivot coordinates for a transformation for the second term, and selects the corresponding transformation matrix as follows:

$$T \{ {\sum }_{i = 1}^{N - 1} ( {x}_{i} , {y}_{i} ) - N ( {x}_{pivot} , {y}_{pivot} ) \} \qquad ( 4 )$$

The pivot point can be selected based upon the transformation. For example, there may be two sets of patterns, A and B, where B is identical with A after applying the reflect-X operation. If A is defined as a pattern with the lower left corner as the pivot, then the reflected version of B must also have the pivot at its lower left corner. Thus, the pivot point for the original position of B must be at its upper left corner. This logic can be applied to derive the pivots for all cases.

In comparing two sets of patterns of geometric element features, various implementations of the repair region classification component 507 employ formula (4) to evaluate all eight transformation cases for one of the patterns. For the other pattern, the repair region classification component 507 only employs formula (3) once, without applying transformation matrices, to evaluate the pattern. Then, if the evaluated value for the second pattern matches any one of the eight values calculated for the first pattern, the repair region classification component 507 concludes that there is a likelihood of a match between the two patterns. Further, identifying the matching value of the eight calculated value indicates which transformation matrix is appropriate.

Once the match is found based on this metric evaluation, various embodiments of the repair region classification component 507 will still use the appropriate transform for a vertex by vertex comparison of the two patterns, to ensure a definite match. But the repair region classification component 507 need only perform this resource-intensive operation if a match applying the pattern characteristics to the internal-vertex-sum metric described above has already found.

Employing the pattern characteristics in a matching metric as described above, the repair region classification component 507 examines the repair regions in the layout design data and categorizes repair regions having identical patterns of geometric element features into the same classes. For example, with some implementations, the repair region classification component 507 will select a repair region and analyze the pattern of geometric element features in the selected repair region to determine if it matches the pattern of geometric element features in a previously-analyzed repair region. If it does, then the selected repair region is categorized in the same class as the previously-analyzed repair region. If it does not, then the selected repair region is categorized in a new class of repair regions. That is, the selected repair region forms the basis of a new class of repair region. This process may be repeated until all repair regions in the layout design data have been classified.

With some implementations of the repair region classification component 507, pattern classification potentially involves the comparison of all possible combinations of two patterns among all possible patterns. However, various implementations of the repair region classification component 507 employ the pattern characteristics to more efficiently filter out pattern combinations that do not match. For example, it is only necessary to compare the pattern of a selected repair region with the pattern of only one repair region from each class, as the repair regions within a single class will have the same patterns. Further, some implementations of the repair region classification component 507 will compile lists of the repair regions that have the same geometric element count and the same vertex count. For a selected repair region, the repair region classification component 507 need only check the internal vertex sum for all transforms of the pattern against the patterns for those repair regions that belong to the same such list, in to further narrow down the candidates for a match. Once a pattern match between two regions is found using the internal-vertex-sum metric, then the repair region classification component 507 performs a vertex by vertex comparison of the two patterns to confirm a definite match. Experiments have shown that this scheme is efficient, and examples have been able to classify two hundred thousand repair regions in less than a minute using a single thread operating in a conventional computing system.

Once the repair region classification component 507 has categorized a repair region in a class, it can record that relationship using any applicable technique. For example, with some implementations, an identifier of each repair region is stored in a table. The identifier may be, for example, the location of the hotspot defining the repair region, but other identifiers may alternately or additionally be employed. When the repair region classification component 507 determines that a selected repair region belongs to a class, the repair region classification component 507 can modify the table entry for the class-founding repair region for that class to include a pointer to the selected repair region, as shown in FIG. 14, or vice versa.

If the layout design data is hierarchical, various examples of the repair region classification component 507 further classify the repair regions using the hierarchical cells making up the layout design data. For example, with some implementations of the invention, the repair region classification component 507 will select a representative repair region for each class (e.g., the class-founding repair region), and determine a hierarchical cell that contains the pattern of geometric element features for that repair region.

More particularly, the repair region classification component 507 will identify a cell that contains the geometric elements within a repair region (for example, the geometric elements 1003-1007 for repair regions 1001A and 1001B shown in FIGS. 10A and 12A). If a single cell does not contain all of the geometric elements, then the repair region classification component 507 will promote those cells to identify a higher-level cell containing them. This process is repeated until a cell is identified that contains all of the geometric elements of the repair region. As will be appreciated from the discussion of hierarchical layout design data, above, the relationship between cells and geometric elements can be represented as a “tree” structure, with the geometric elements being “leaves” and the cells being “branches.” Accordingly, the repair region classification component 507 can start with the geometric elements within the repair region, and traverse upward through a tree structure representing the hierarchical layout design data until it reaches a cell or “branch” from which all of those geometric elements (“leaves”) directly or indirectly depend.

With various implementations, the repair region classification component 507 will select the lowest hierarchical cell common to all of the geometric elements in the repair region. Still other implementations, however, may select a higher cell that is common to all of the geometric elements in the repair region. In any case, once the repair region classification component 507 selects a cell that contains all of the geometric elements within the representative repair region, the repair region classification component 507 will include the cell as a characteristic for that class of repair regions. This process may be repeated until each class of repair regions also has an associated cell characteristic for the geometric element feature patterns of that class.

In still other implementations, the repair region classification component 507 may identify a common cell (either the lowest cell or a higher cell) for every repair region within a class. These alternate implementations may be useful, for example, when independent hierarchical cells could still contain the same geometric element feature pattern (e.g., where unrelated cells might coincidentally contain the same geometric element feature pattern). Also, while the repair region classification component 507 has been described as determining the common cell characteristic for a class of geometric element feature patterns, with some implementations the pattern characteristic extraction component 505 may determine the common cell for the geometric element features of a repair region when determining the other pattern characteristics for that repair region. With these implementations, the common cell may be used to help classify the geometric element feature patterns. For example, with some of these implementations, the repair region classification component 507 may only compare the other characteristics of geometric element feature patterns of different repair regions if they have the same common cell.

Depending upon the consistency of the layout design data, the position of the hotspot marker relative to the geometric element features may vary between repair regions. For example, as shown in FIGS. 12A and 12B, the hotspot marker 1009A is closer to geometric element 1005 in FIG. 12A than the hotspot marker 1009B is to geometric element 1005 in FIG. 12B. Likewise, the hotspot marker 1009B is closer to geometric element 1003 in FIG. 12B than the hotspot marker 1009A is to geometric element 1003 in FIG. 12A. Because of this difference in hotspot marker location, the repair region 1001B is shifted relative to repair region 1001A with respect to geometric elements 1003-1007.

As discussed in detail above, if the shift between repair regions is not too significant, implementations of the pattern characteristic extraction component 505 will still extract the same geometric element feature pattern characteristics from both repair regions, and the classification component 507 will still categorize the geometric element feature patterns from both repair regions in the same class. With some implementations, the repair region definition component 503 may employ a common classification to adjust shifted repair regions. More particularly, if two repair regions with the same class are shifted with respect to the shared geometric element features, the repair region definition component 503 may shift the position of the hotspot marker so that the repair regions align with respect to their shared geometric element features. With some implementations, the repair region definition component 503 may move the hotspots so that all repair regions in a class are aligned with the founding repair region for that class. Alternately, the repair region definition component 503 may align all of the repair regions in a class to match the most frequently-occurring hotspot position in that class. In this manner, the repair region definition component 503 may ensure that all of the repair regions within each class are aligned with respect to the geometric element feature patterns in those repair regions.

With some implementations, the pattern characteristic extraction component 505 and the repair region classification component 507 will operate upon target layout design data. For still other implementations, the pattern characteristic extraction component 505 and the repair region classification component 507 will alternately or additionally operate upon enhanced layout design data generated from the target layout design data.

As noted above, target layout design data describes the intended shapes or features to be printed in a photolithographic manufacturing process, and it ordinarily is the initial layout data created for a design. In order to print the desired image during a conventional modern photolithographic manufacturing process, however, it typically is necessary to enhance the target layout design data, as discussed in detail above. The enhanced layout design data is usually more complex than the initial target layout design data. For example, the multi-width polygon 301′ shown in FIG. 3B is enhanced layout design data corresponding to target layout design data represented by the rectangle 301 shown in FIG. 3A. With some implementations of the layout design database 511, target layout design data may be stored as a one “layer” of data, while the corresponding enhanced layout design data is stored as another layer of data. Additional design objects, such as the hotspot markers, can be stored in still other layers.

Accordingly, some implementations of the pattern characteristic extraction component 505 and the repair region classification component 507 may employ target layout design data to categorize the repair regions into classes. Still other implementations of the pattern characteristic extraction component 505 and the repair region classification component 507 may alternately or additionally employ enhanced layout design data to categorize the repair regions into classes. As will be appreciated by those of ordinary skill in the art, because enhanced layout design data typically is more complex than its corresponding target layout design data, employing the enhanced layout design data may produce more classes than using the target layout design data. For example, two repair regions may have the same geometric element features for the target layout design data. After that target layout design data has been enhanced, however, the repair regions may contain very different geometric element feature patterns because of the impact of surrounding geometric element features during the enhancement process.

As will be discussed in more detail below, with some implementations, the pattern characteristic extraction component 505 and the repair region classification component 507 will employ both the target layout design data and the corresponding enhanced layout design data to categorize the repair regions into classes. More particularly, the pattern characteristic extraction component 505 and the repair region classification component 507 will employ the target layout design data to categorize the repair regions into a first set of classes. The pattern characteristic extraction component 505 and the repair region classification component 507 will also employ the corresponding enhanced layout design data to categorize the repair regions into second set of classes that may be different from the first set of classes.

### Re-Optimization and Stitching of Repair Regions

In operation 607, the lithographic repair tool 509 applies a common lithographic repair to the repair regions of a class. With some implementations, the lithographic repair tool 509 will devise a repair for a single repair region in a class, such as the founding repair region. After having established the repair, the lithographic repair tool 509 will then apply that repair to all other repair regions in the class. With still other implementations, however, where a common cell has been identified for the repair regions in a class (or a sub-group of repair regions in the class), then the lithographic repair tool 509 will apply the repairs to the elements of that cell, so that the repair is propagated to all instances of the cell.

The lithographic repair tool 509 may be a conventional lithographic repair tool, such as the Calibre® nmOPC lithographic repair tool or Calibre® px OPC lithographic repair tool available from Mentor Graphics® Corporation of Wilsonville, Oreg., or the Proteus OPC lithographic repair tool or Inverse Explorer lithographic repair tool available from Synopsys,® Inc., of Mountain View, Calif. As will be appreciated by those of ordinary skill in the art, the lithographic repair tool 509 analyzes the geometric element features within a repair region. Based upon that analysis, the lithographic repair tool 509 “repairs” (that is, enhances) the geometric element features to improve the printability of the target features. For example, the lithographic repair tool 509 may apply an optical proximity correction technique to the geometric element features within a repair region, to improve the printability of the image created by those features in a lithographic manufacturing process. As previously noted, for a selected repair region, the lithographic repair tool 509 will enhance the layout design within the core region 703 based upon the surrounding layout design data in the context region 705 and the visible region 707. Typically, the geometries in the context region 705 are mostly kept intact. However, modifications of shapes in the core region 703 may necessitate some adjustments of shapes in the context region 705 to avoid abrupt shift of shapes at the border.

Once the lithographic repair tool 509 has enhanced the data within the core region 703, various implementations will “stitch” this repaired data back into the overall design in place of the layout design data previously in the core region 703 and the context region 705. As previously noted, the context region 705 provides a buffer for stitching the newly-enhanced data in the core region 703 into the center of the visible region 707. With some implementations, the computational lithography tool performs the stitching by gradually reducing the rate of geometrical modifications toward the border of the context region 705 with the visible region 707, such that the full geometry optimization is performed at the border of the core region 703 with the context region 705, whereas the geometries are completely frozen at the border of the context region 705 with the visible region 707.

With some implementations, the lithographic repair tool 509 will replace the prior layout design data being repaired by, e.g., replacing the geometric elements in the core region 703 and the context region 705 of the original layout data with the geometric elements in the core region 703 and the context region 705 of the repaired layout design data. Still other implementations of the lithographic repair tool 509 alternately may replace only the geometric element features in the prior layout design data that has been repaired. Further, as used herein, “stitching” also includes implementations where the lithographic repair tool 509 repairs the prior layout design data directly, without requiring a copy of the prior layout design data to be separately modified and substituted back into the layout design. It should be appreciated that, in replacing or repairing the prior layout design data, the lithographic repair tool 509 may employ any conventional data merging techniques, such as using mask rule checks (MRC) to ensure that the resulting repaired layout design data comply with relevant manufacturing rules.

With various implementations, the lithographic repair tool 509 will apply the same repair solution to every repair region in a class. For example, a class may contain hundreds or even thousands of repair regions distributed across the topography of a design. Because all of the repair regions share a common geometric element feature pattern, the lithographic repair tool 509 need only determine a repair solution for one of the repair regions in the class (for example, the founding repair region for the class). The same repair solution can then be applied to the other repair regions with little or no modification, greatly reducing the time and resources necessary to repair those regions. For example, the lithographic repair tool 509 may determine a repair for the pattern of geometric element features in a first repair region in a class. As discussed in detail above, the second repair region in that class will have the same pattern, subject to a transformation (translation, rotation or reflection). As also noted above, the repair region classification component 505 determines the appropriate transform for the second repair region relative to the first repair region. By using this transform, the lithographic repair tool 509 can apply the same repair solution to the second repair region as the first repair region.

Thus, the lithographic repair tool 509 applies the same repair to all of the repair regions in a class. The lithographic repair tool 509 will then determine and apply a common repair to all of the repair regions in another class. This process is repeated until a common repair has been determined and applied to each class of repair regions in the design. In this manner, all of the hotspots in a layout design can be efficiently repaired.

As previously noted, in some implementations the characteristics of a geometric element feature pattern will also include a hierarchical cell that includes all of the geometric element features making up that pattern. With these implementations, the lithographic repair tool 509 may repair the cell containing those geometric element features rather than repairing multiple repair regions across a layout design. More particularly, the lithographic repair tool 509 will “flatten” the hierarchical cell that includes all of the geometric element features making up a pattern. The lithographic repair tool 509 will then enhance the layout data for the geometric elements having those features, to improve their printability. After the appropriate layout design data has been enhanced, the lithographic repair tool 509 will stitch the enhanced layout design data back into the common cell (either directly into the common cell, into a dependent cell, or some combination of both).

For example, with the geometric elements 1003-1007 shown in FIGS. 12A and 12B, geometric elements 1003 and 1005 may be placed within a hierarchical cell A, while geometric element 1007 may be placed within a hierarchical cell B, with a cell C containing a placement of both cell A and cell B so as to provide the geometric element feature pattern in repair region 1001A. With these implementations, the lithographic repair tool 509 will flatten cell A and cell B to obtain the geometric element feature pattern shown in FIG. 12A. After determining the enhancements to improve the printability of this pattern, the lithographic repair tool 509 will apply the relevant enhancements to the geometric elements 1003 and 1005 in the instance of hierarchical cell A placed in hierarchical cell C. Similarly, the lithographic repair tool 509 will apply the relevant enhancement to the geometric element 1007 in the instance of hierarchical cell B placed in hierarchical cell C. (As will be appreciated by those of ordinary skill in the art, other instances of cell A or cell B may be placed in alone or in different cells apart from the other.)

By promoting the repair solution for a class of geometric element feature patterns into a hierarchical cell that contains all of those geometric element features, these implementations will inherently propagate the repair solution across the design. That is, any placement of the hierarchical cell containing the pattern of geometric element features making up the class will thus inherently include the repair solution determined by the lithographic repair tool 509.

### Verification of Repair Regions

In optional operation 609, the repair verification tool 511 verifies the repairs to the hotspots made by the lithographic repair tool 509. The repair verification tool 511 may be implemented using any suitable lithographic verification tool, such as the Calibre® OPCverify™ verification tool available from Mentor Graphics® Corporation of Wilsonville, Oreg., or the Proteus LRC verification tool available from Synopsys®, Inc. of Mountain View, Calif. With various implementations, the repair verification tool 511 will analyze and verify each hotspot individually. With still other implementations, however, the repair verification tool 511 will employ the hotspots classification made by the repair region classification component 507.

More particularly, with some embodiments, the repair verification tool 511 will analyze select a representative repair region from a class of repair regions. The repair verification tool 511 will then perform a verification process on the selected repair region. Depending upon the application of the repair verification tool 511, the verification process may provide a variety of analysis results including, for example, an indication that the repair region no longer contains undesirable geometric element features, an indication that the repair region contains undesirable geometric element features associated with the original manufacturing problem for the repair region, or an indication that the repair region contains undesirable geometric element features associated with a new manufacturing problem. With various implementations, the repair verification tool 511 will then apply the verification results to all of the repair regions in the class. The repair verification tool 511 will then select a repair region from a new class, and repeat the process until verification results have been applied to the repair regions in every class.

With some implementations, the verification results may include orientation-specific information, such as the placement of a new hotspot within the repair region. For this information, the repair verification tool 511 can employ the transformation matrix T previously determined for each repair region, as discussed in detail above, to accurately apply the verification results to individual repair regions.

As previously noted, some implementations of the repair region classification component 507 will create classes containing multiple repair regions spread across a design. With still other implementations, however, the repair region classification component 507 will create hierarchical classes, where a class includes a common cell that contains the geometric element features shared among all of the repair regions assigned to that class. With these implementations, the repair verification tool 511 may associate the verification results with each of the repair regions assigned to a class by associating the results with the common cell that contains the geometric element features shared among all of the repair regions assigned to the class, so that the verification results are propagated with each instance of the common cell.

Also, with various implementations, the repair verification tool 511 may employ a different set of classes than the lithographic repair tool 509. As discussed in detail above, with some embodiments, the repair region classification component 507 may create two sets of classes: a target group of classes based upon target layout design data, and an enhanced group of classes based upon enhanced layout design data. More particularly, the pattern characteristic extraction component 505 will identify characteristics of the target layout design data for the repair regions, and the repair region classification component 507 will categorize the repair regions into a first set of classes based upon those target layout design data characteristics. The pattern characteristic extraction component 505 also will identify characteristics of the enhanced layout design data for the repair regions, and the repair region classification component 507 will categorize the repair regions into a second set of classes based upon those enhanced layout design data characteristics. With various implementations, the lithographic repair tool 509 will employ the target classes created using the target layout design data, while the repair verification tool 511 will employ the enhanced classes created using the enhanced layout design data.

As will be appreciated by those of ordinary skill in the art, separate instances of the same geometric element features may be enhanced differently, based upon their individual context (e.g., surrounding geometric element features). Thus, classifying repair regions based upon enhanced layout design data typically will produce more classes than classifying repair regions based upon target layout design data. Correspondingly, however, because a verification process should be applied to enhanced data, associating verification results with repair region classes based on enhanced layout design data will provide better accuracy.

### CONCLUSION

As described above, various implementations of a hotspot repair tool and hotspot repair techniques can provide efficient identification and repair of hotspots within a layout design. It should be appreciated that, while various tools and techniques have been described above, these descriptions are not intended to be limiting. For example, some implementations may employ parallel operations to increase the efficiency of the described technology. Thus, with some implementations, multiple repair regions can be classified in parallel, or portions of the classification process can be performed in parallel. Alternately or additionally, a repair process can be performed on multiple representative repair regions in parallel. Still further, a verification process can be performed on multiple representative repair regions in parallel

While the technology has been described with respect to specific examples including presently preferred modes for the disclosed technology, those skilled in the art will appreciate that there are numerous variations and permutations of the above described systems and techniques that fall within the spirit and scope of the invention as set forth in the appended claims. For example, while specific terminology has been employed above to refer to electronic design automation processes, it should be appreciated that various examples of the invention may be implemented using any desired combination of electronic design automation processes.

What is claimed is:

1. A method of correcting lithographic manufacturing errors in a layout design for a microdevice, comprising
defining repair regions in the layout design;
determining pattern characteristics for the repair regions;
categorizing the repair regions into classes based upon the determined pattern characteristics;
determining a lithographic repair solution for a repair region in a selected class of repair regions; and
applying the lithographic repair solution to repair regions in the selected class.

2. The method recited in claim 1, wherein,
determining the pattern characteristics for the repair regions includes using target layout data and enhanced layout data;
categorizing the repair regions includes categorizing the repair regions into target classes and enhanced classes;
determining the lithographic repair solution includes determining the lithographic repair solution for the repair region in a selected target class of repair regions; and
applying the lithographic repair solution includes applying the lithographic repair solution to repair regions in the selected target class.

3. The method recited in claim 2, further comprising:
determining a lithographic verification process for a repair region in a selected enhanced class of repair regions; and
applying the lithographic verification process to other repair regions in the selected enhanced class.

4. The method recited in claim 2, wherein applying the lithographic repair solution to repair regions in the selected target class includes applying the lithographic repair solution to multiple repair regions in flat layout design data.

5. The method recited in claim 2, wherein applying the lithographic repair solution to repair regions in the selected target class includes:
determining a cell in hierarchical layout design data that includes design elements of the repair regions in the selected target class, and
applying the lithographic repair solution to the cell.

6. The method recited in claim 1, wherein applying the lithographic repair solution to repair regions in the selected class includes applying the lithographic repair solution to multiple repair regions in flat layout design data.

7. The method recited in claim 1, wherein applying the lithographic repair solution to repair regions in the selected class includes:
determining a cell in hierarchical layout design data that includes design elements of the repair regions, and
applying the lithographic repair solution to the cell.

8. The method recited in claim 1, wherein applying the lithographic repair solution to repair regions in the selected class includes:
creating corrected layout design data, and
stitching the corrected layout design data into the layout design.
